(19) United States
(12) Patent Application Publication
(10) Pub. No.: US 2023/0280599 A1
(43) Pub. Date: Sep. 7, 2023

(54) SIMULATING OF THREE-DIMENSIONAL GARMENT WITH PADDING MATERIAL

(71) Applicant: CLO Virtual Fashion Inc., Seoul (KR)

(72) Inventors: Ho Hyun LEE, Seoul (KR); Jae Hoon LEE, Seoul (KR); Kwang Yun KIM, Seoul (KR); Gi Seong YUN, Seoul (KR); Gang Ho KIM, Seoul (KR)

(21) Appl. No.: 18/317,334

(22) Filed: May 15, 2023

Related U.S. Application Data
(63) Continuation of application No. PCT/KR2022/018331, filed on Nov. 18, 2022.

(30) Foreign Application Priority Data
Nov. 19, 2021 (KR) 10-2021-0160365
Nov. 18, 2022 (KR) 10-2022-0155377

(51) Int. Cl. G02B 30/52; G06F 30/20

(52) U.S. Cl. CPC G02B 30/52; G06F 30/20; G06F 2113/12

(57) ABSTRACT

According to an embodiment, a method of simulating a three-dimensional (3D) padded garment includes generating a second pattern corresponding to a first pattern that is a two-dimensional (2D) pattern, generating an intermediate pattern positioned between the first pattern and the second pattern to which a pressure value is applied, wherein the intermediate pattern comprises a collision value, and generating the 3D padded garment based on at least one of the first pattern, the second pattern, and the intermediate pattern.

### CROSS-REFERENCE TO RELATED APPLICATIONS

This is a bypass continuation-in-part application of International Application No. PCT/KR2022/018331, filed on Nov. 18, 2022, which claims priority to Republic of Korea Patent Application No. 10-2021-0160365, filed on Nov. 19, 2021, and Republic of Korea Patent Application No. 10-2022-0155377, filed on Nov. 18, 2022, which are incorporated by reference herein in their entirety.

### TECHNICAL FIELD

The following embodiments relate to a method and device for simulating a 3-dimensional (3D) padded garment.

### BACKGROUND ART

A padded garment may include soft materials such as cotton and down to protect a body or change the appearance of the garment. Padding may be added to the garment as a thin cushion material. In order to simulate the padded garment, a realistic representation of the padded garment may be required. Depending on the filling included in the padded garment, the shape of the padded garment may vary. Therefore, outputting a three-dimensional (3D) padded garment on a display screen, like a real padded garment, may be important for people designing the padded garment. Accordingly, research and investment in technology for simulating padded garments are on the rise.

### SUMMARY

Embodiments relate to simulating a three-dimensional (3D) padded garment. A two-dimensional shape of a first pattern of the 3D padded garment is received. A two-dimensional shape of a second pattern of the 3D padded garment is generated. The second pattern is combined with the first pattern with an intermediate pattern sandwiched between the first pattern and the second pattern to form at least a portion of the 3D padded garment. The appearance of the 3D padded garment is simulated by applying internal pressure by the intermediate pattern as defined by a pressure value to an internal surface of the first pattern facing the second pattern and an internal surface of the second pattern facing the first pattern. Further, collision processing of the intermediate pattern is performed by applying a collision value of the intermediate pattern representing a collision processing range of the intermediate pattern. The result of the simulation is displayed.

In one or more embodiments, the intermediate pattern is automatically generated.

In one or more embodiments, the intermediate pattern is not displayed.

In one or more embodiments, the first pattern and the second pattern are transformed in 3D space based on at least one of physical property of the first pattern, physical property of the second pattern, the pressure value or the collision value to perform the translation.

In one or more embodiments, a configuration of the 3D padded garment is generated by generating at least one sewing line that combines the first pattern, the second pattern, and the intermediate pattern based on an interval of the sewing line.

In one or more embodiments, the sewing line defines a plurality of padded sections in the 3D padded garment.

In one or more embodiments, another sewing line parallel to the sewing line and spaced apart by a predetermined distance from the swing line is generated.

In one or more embodiments, a wrinkle on a padded surface is generated based on the sewing line and the other sewing line.

In one or more embodiments, simulating the appearance of the 3D padded garment is performed by applying an elastic value to at least one of the sewing line or the other sewing line.

In one or more embodiments, the height of a padded section including the intermediate pattern is determined based on the pressure value.

In one or more embodiments, the pressure value includes at least one of: a first pressure value applied to the internal surface of the first pattern in a direction opposite to the second pattern; or a second pressure value applied to the internal surface of the second pattern in a direction opposite to the first pattern.

In one or more embodiments, a curvature of a padded surface is determined by adjusting, based on the collision value, a gap between the first pattern and the second pattern with an increase in distance from the sewing line.

In one or more embodiments, the pressure value is determined based on at least one of an interval between sewing lines and filling information indicating materials that fill the 3D padded garment. The collision value is determined based on at least one of the intervals between sewing lines connecting the first pattern and the second pattern, and the filling information.

In one or more embodiments, filling information of each of a plurality of patterns of the 3D padded garment is determined based on an area of each of the plurality of patterns. The filling information indicates materials that fill the 3D padded garment.

In one or more embodiments, the size of a mesh in the first pattern and the second pattern, or a size of a mesh in the intermediate pattern is adjusted.

In one or more embodiments, the filling information indicates at least one of a filling material, a mass of a filling that fills the 3D padded garment, or a weight of the filling.

In one or more embodiments, the weight of the filling is set for each unit area of the intermediate pattern.

### BRIEF DESCRIPTION OF DRAWINGS

FIG. 1 is a flowchart illustrating a method of simulating a three-dimensional (3D) padded garment, according to an embodiment.

FIG. 2 is a diagram illustrating a first pattern, a second pattern, and an intermediate pattern, according to an embodiment.

FIG. 3 is a diagram illustrating a wrinkle on a padded surface, according to an embodiment.

FIG. 4 is a diagram illustrating a collision value according to an embodiment.

FIG. 5 is a diagram illustrating a method of determining filling information based on an area of pattern pieces, according to an embodiment.

FIG. 6 is a diagram illustrating simulation properties, according to an embodiment.

FIG. 7 is a diagram illustrating information for determining a pressure value and a collision value, according to an embodiment.

FIG. 8 is a block diagram illustrating an electronic device according to various embodiments.

### DETAILED DESCRIPTION

The following structural or functional descriptions are exemplary to merely describe the example embodiments, and the scope of the example embodiments is not limited to the descriptions provided in the present specification.

Although terms of “first” or “second” are used to explain various components, the components are not limited to the terms. These terms should be used only to distinguish one component from another component. For example, a “first” component may be referred to as a “second” component, or similarly, a “second” component may be referred to as a “first” component within the scope of the right according to the concept of the present disclosure.

It will be understood that when a component is referred to as being “connected to” or “coupled to” another component, the component can be directly connected or coupled to the other component or intervening components may be present. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more of other features, integers, steps, operations, elements, components, and/or groups thereof.

Hereinafter, examples will be described in detail with reference to the accompanying drawings. In the drawings, like reference numerals refer to like components.

Clothes (or garments) appear in three dimensions when worn on a person's body, but they are more in two dimensions because they are actually a combination of pieces of fabric cut according to a two-dimensional (2D) pattern. Because fabric that is a material for clothes is flexible, it may vary in appearance from moment to moment according to a body shape or the motion of a person who wears it. For example, clothes worn on a body may slip down or become wrinkled and folded by gravity, the wind, or collisions with the body. In this case, the aspect of the clothes flowing down or wrinkling may vary depending on physical properties of the fabric. To simulate clothes made of flexible materials, such as a fabric, in three dimensions, an approach different from modeling of objects made of rigid materials may be used.

Clothing patterns according to an embodiment may be virtual 2D patterns modeled as a sum of numerous triangular meshes for simulating 3D virtual clothes. Three vertices of the mesh are point masses with mass and each side of the mesh may be expressed as springs with elasticity connecting the mass. Thus, the patterns may be modeled, for example, by a mass-spring model. The springs may have respective resist values against, for example, stretch, shear, and bending, depending on the material property of the fabric used. Each vertex may move according to the action of an external force such as gravity, and the action of an internal force such as stretch, shear, and bending. When a force being applied to each vertex is obtained by calculating the external force and the internal force, the speed of movement and displacement of each vertex may be obtained. Also, the movement of the clothes may be simulated through a movement of the vertices of the mesh at each time step. The simulation based on physical laws may be to drape 2D virtual clothes patterns made of triangular meshes on a 3D avatar. Accordingly, the simulation based on the physics laws may implement natural 3D virtual clothes based on the physical laws.

Embodiments relate to realistically expressing padding in a 3D clothes simulation. The simulation of a 3D padded garment may be performed based on the above-described physical laws-based simulation. Deformation may be applied to a first pattern and a second pattern indicating a padded surface based on physical properties of a fabric and/or external force. Furthermore, in the present disclosure, when the physical properties, the external forces, and a filling between the first pattern and the second pattern exist, force (e.g., a pressure applied to the pattern or a collision between the pattern and the filling) act on the first pattern and the second pattern to deform one or more of these patterns.

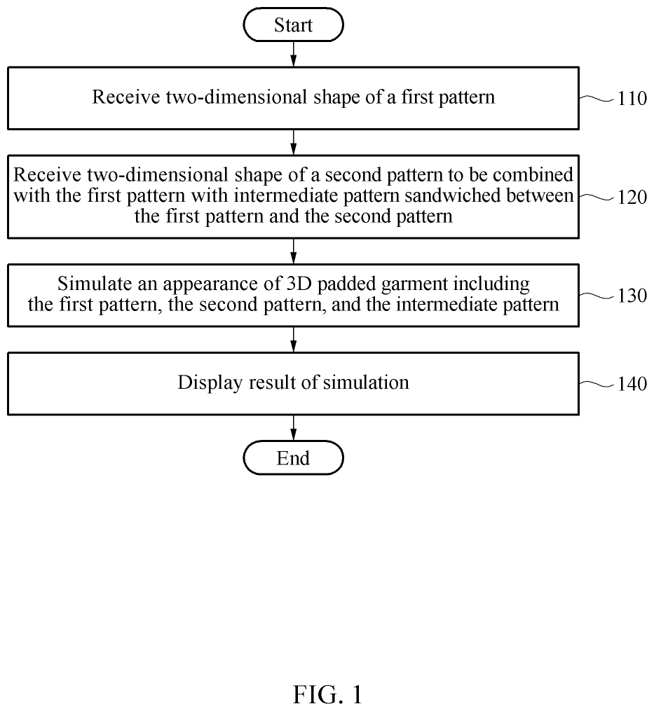

FIG. 1 is a flowchart illustrating a method of simulating a three-dimensional (3D) padded garment, according to an embodiment. In operation 110, a processor 810 according to an embodiment may receive a two-dimensional shape of a first pattern. The shape of the first pattern may be provided by a user input or by reading data from memory.

In operation 120, the processor 810 generates a two-dimensional shape of a second pattern. The second pattern is to be combined with the first pattern with an intermediate pattern sandwiched between the first and second patterns to form a part of the 3D padded garment. The second pattern may be generated in various ways including, but not limited to, by receiving user input, by reading from memory, or by duplicating the first pattern as a second pattern.

When the first pattern is an outer surface of the 3D padded garment, for example, the second pattern may be an inner surface of the 3D padded garment. Conversely, when the first pattern is the inner surface of the 3D padded garment, the second pattern may be the outer surface of the 3D padded garment. That is, the first pattern and the second pattern may be patterns positioned opposite to each other in the 3D padded garment. In one or more embodiments, the second pattern may be a cloned version of the first pattern. The second pattern may be generated automatically from the first pattern by the processor 810.

The processor 810 may generate an intermediate pattern (a filler pattern) positioned between the first pattern and the second pattern to which a pressure value is applied. The intermediate pattern may be associated with a collision value. The intermediate pattern according to an embodiment may include information for generating the 3D padded garment. The intermediate pattern (also referred to as “filler” herein) may be a pattern that serves as a virtual filling in the 3D padded garment simulation. In order to express the 3D padded garment, the processor 810 may express the 3D padded garment differently according to the filling included between the first pattern and the second pattern to which a pressure value is applied. For example, the 3D padded garment may vary depending on whether the filling is cotton, goose down, duck down, or a combination thereof. Accordingly, the processor 810 may display the 3D padded garment on a display screen by transforming the first pattern and the second pattern based on the pressure value and/or the collision value. The first pattern and the second pattern may be displayed on the display screen. However, since the intermediate pattern is a pattern associated with information necessary to express the 3D padded garment, the intermediate pattern may or may not be displayed on the display screen.

The intermediate pattern according to an embodiment may be associated with physical property information. As described above, patterns are simulated by reflecting the physical property of the patterns. The first pattern and the second pattern may have certain physical properties as defined in their respective physical property information. The physical property information according to an embodiment may include information on unique properties of the filling. According to another embodiment, the physical property information may include physical property information of a fabric. The physical property information of the fabric may include, for example, strength weft, strength warp, shear, bending, buckling ratio, buckling ratio strength, internal damping, density, friction coefficient, and the like. Each physical property may affect each other and values of all physical properties may be mixed and expressed on the 3D padded garment.

The pressure value described herein indicates a pressure applied outward from an inner surface of the first pattern or the second pattern of the 3D padded garment. For example, a pressure applied outward from the inner surface of the first pattern of the 3D padded garment may be a positive (+) pressure value (e.g., a first pressure value) and a pressure applied outward from the inner surface of the second pattern may be a negative (−) pressure value (e.g., a second pressure value). Accordingly, a direction of the first pressure value applied to the first pattern and a direction of the second pressure value applied to the second pattern may be opposite to each other. The pressure value according to an embodiment may be a value applied to the first pattern and the second pattern that are surfaces of the 3D padded garment. For example, as the pressure value increases, the volume of the 3D padded garment may increase. As another example, as the pressure value increases, the height of a padded section in the 3D padded garment may also increase.

The collision value described herein refers to a collision processing range of garments or patterns. Simulating with the collision value enables smooth simulation of the garments or their patterns. The collision value may be regarded as a non-visualized virtual thickness of the intermediate pattern. The collision value sets a thickness of a pattern or a part of a garment so that other patterns or other parts of garments do not intrude upon the area near the pattern or the part of the garment. For example, when the collision value is set to 3 millimeters, the thickness of the intermediate pattern may be treated as being 3 millimeters. In other words, parts of the first pattern and the second pattern may not occupy an area that is within 3 millimeters from the intermediate pattern. The collision value may be determined based on filling information or based on a user selection. For example, the collision value may be determined based on the filling information corresponding to the filling selected by a user. By adjusting the collision value, a virtual thickness of the intermediate pattern may be adjusted so that natural and realistic simulation results may be obtained. For example, since the thickness of the intermediate pattern is determined based on the collision value, and a distance between the first patterns (or the second patterns) is adjusted, a degree of bending of the padded surface may be adjusted as a distance from an inner sewing line increases. The processor 810 may adjust the degree of bending of the padded surface to be gentler as the distance from the inner sewing line increases. For example, as the collision value decreases, the distance between the first pattern and the second pattern may gently increase as the distance from the inner sewing line increases. The processor 810 may adjust the degree of bending of the padded surface so that the degree of bending of the padded surface becomes steeper as the distance from the inner sewing line increases. For example, as the collision value increases, the distance between the first pattern and the second pattern may rapidly increase as the distance from the inner sewing line increases. Accordingly, the processor 810 may realistically express the padded surface using the collision value.

In operation 130, the processor 810 \ may simulate the 3D padded garment based on at least one of the first pattern, the second pattern, and the intermediate pattern. The processor 810 may determine the padded surface of the 3D padded garment based on at least one of physical property information, the pressure value, and the collision value. The surface of the 3D padded garment may be the first pattern and the second pattern. In addition, the processor 810 may transform the first pattern and the second pattern in order to express the 3D padded garment. By transforming the first pattern and the second pattern, the padded surface of the 3D padded garment may be determined.

Since the initial first pattern and the initial second pattern according to an embodiment are 2D patterns, they may be positioned parallel to each other. However, in 3D, a plurality of padded sections may be generated on the padded garment based on one or more quilting lines. In addition, the degree to which the filling is filled may be determined differently for each padded section, and a curve may occur on the surface of the padded garment. Therefore, in order to express a realistic 3D padded garment, the processor 810 may generate the 3D padded garment by transforming the first pattern and the second pattern that become surfaces of the 3D padded garment.

The simulation includes applying internal pressure by the intermediate pattern as defined by a pressure value to an internal surface of the first pattern facing the second pattern and an internal surface of the second pattern facing the first pattern. Further, the simulation includes performing collision processing of the intermediate pattern, the first pattern and the second pattern by applying a collision value of the intermediate pattern representing a collision processing range of the intermediate pattern.

According to an embodiment, an interval between inner sewing lines may be reflected in simulation. The inner sewing line is used for dividing one or more portions of a garment into a plurality of padded sections. For example, the inner line may be a quilting line. The quilting described herein refers to a process of manually sewing using a needle and thread or mechanically coupling at least three layers of fabric together using a sewing machine or a quilting system. In quilting, patterns may be emphasized by placing and sewing the filling (e.g., cotton, down, etc.) between fabrics. Therefore, based on the quilting line, the height of the padded section may increase as a distance from the quilting line increases, and the height of the padded section may decrease as the distance from the quilting line decreases.

In operation 140, the result of the simulation may be displayed.

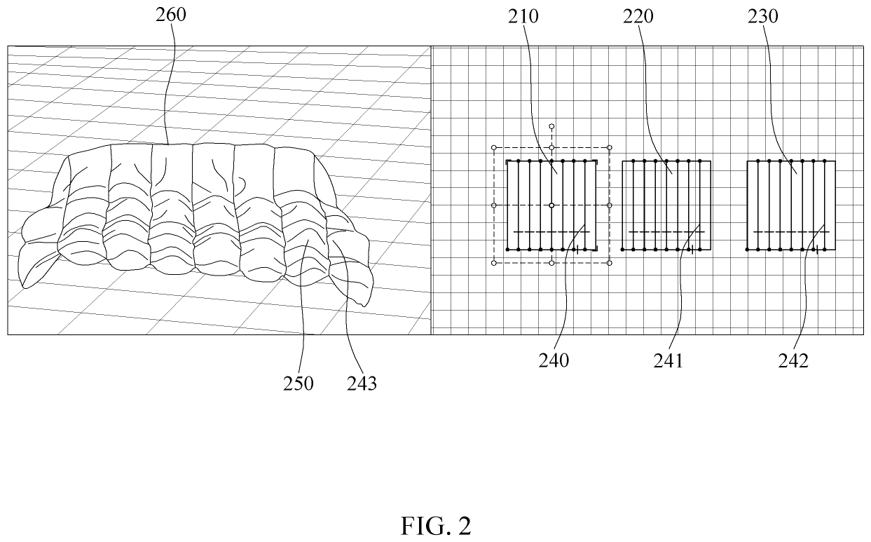

FIG. 2 is a diagram illustrating a first pattern, a second pattern, and an intermediate pattern according to an embodiment. FIG. 2 shows a first pattern 210, an intermediate pattern 220, a second pattern 230, an inner line 240, a padded section 250, and a 3D padded garment 260.

The 3D padded garment 260 may be generated based on the first pattern 210, the intermediate pattern 220, and the second pattern 230, according to an embodiment. For example, in the 3D padded garment 260, an upper surface may correspond to the first pattern 210 and a lower surface may correspond to the second pattern 230. As another example, in the 3D padded garment 260, the upper surface may correspond to the second pattern 230′ and the lower surface may correspond to the first pattern 210.

When the first pattern 210, the intermediate pattern 220, and the second pattern 230 are combined, the processor 810 may combine inner lines 240, 241, and 242 so they overlap. The combined inner lines 240, 241, and 242 may be displayed as an inner sewing line 243 in the 3D padded garment 260.

The padded section according to an embodiment may be described with reference to FIG. 2. In FIG. 2, an inner line 240 (e.g., a quilting line) is shown in two and three dimensions. Also, a padded section 250 may be generated based on a plurality of inner lines. Each of the plurality of padded sections may have the same shape or may have a different shape depending on the interval between the inner lines.

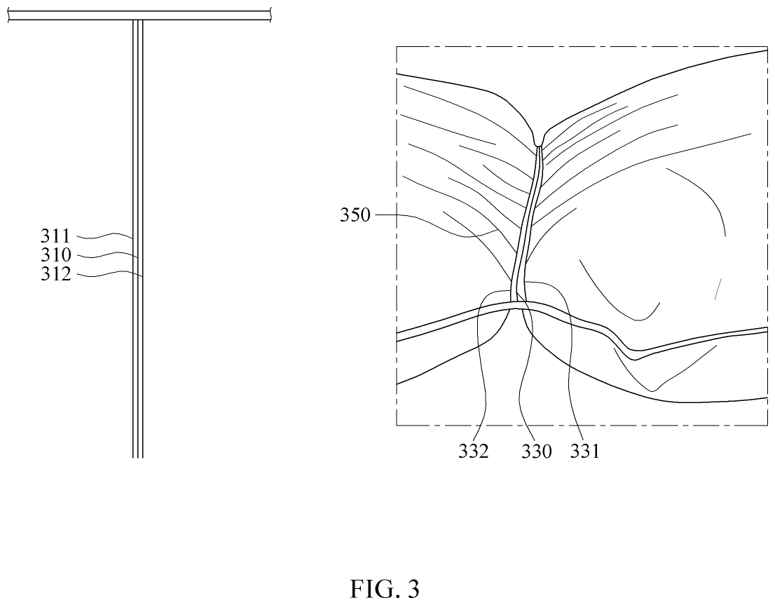

The processor 810 may generate at least one auxiliary line. The auxiliary line is a sewing line parallel to an inner line at a position separated by a predetermined distance from the inner line. Referring to FIG. 3, when an inner line 310 exists in the 2D pattern, the processor 810 may place auxiliary lines 311 and 312 on both sides of the inner line. Since the auxiliary lines become sewing lines, the height of the padded section may be 0 at the auxiliary line. Since the auxiliary lines may be a reference for dividing the padded section, a swollen area may not exist in the corresponding portion. Auxiliary lines 331 and 332 may be positioned on both sides of an inner line 333. Further, these three lines 330, 331, and 332 may be quilting lines that divide the padded section.

The second pattern 230 may be a copy of the first pattern 210.

The intermediate pattern 220 may or may not be displayed on the display screen.

The processor 810 may generate a wrinkle on the padded surface based on at least one of the inner line and the auxiliary line. The processor 810 may generate a wrinkle on the padded surface by applying an elastic value to the inner line and/or the auxiliary line. The elastic value may be a value for providing a visual effect that may contract or extend the inner line and/or auxiliary line by inserting a line having elasticity into the inner line and/or auxiliary line. Users may adjust the degree of the wrinkle on the padded surface by inputting the elastic value. The processor 810 may adjust the degree of the wrinkle of the padded surface based on the elastic value input from users. In an actual padded garment, the wrinkle may be present on the surface of the padded garment due to the quilting line. Accordingly, the processor 810 may generate wrinkles on the padded surface based on at least one of the inner line and the auxiliary line.

FIG. 3 is a diagram illustrating a wrinkle on a padded surface, according to an embodiment. FIG. 3 shows an inner line 310 and auxiliary lines 311 and 312 in the 2D pattern and an inner line 330 and auxiliary lines 331 and 332 in the 3D pattern.

Referring to FIG. 3, when the inner line 310 is provided in the 2D pattern, the processor 810 may place the auxiliary lines 311 and 312 on both sides of the inner line. Since the auxiliary lines become sewing lines, the height of the padded section may be 0 in the auxiliary line portion. Since the auxiliary lines may be a reference for dividing the padded section, a swollen area in the corresponding portion may not exist. The auxiliary lines 331 and 332 may be positioned on both sides of the inner line 330 in the 3D. Further, these three lines 330, 331, and 332 may be quilting lines. Accordingly, the three lines 330, 331, and 332 may be lines dividing the padded section.

In the garment simulation, the wrinkle near the quilting line may be expressed more realistically when there are three quilting lines than when there is only one quilting line. Accordingly, the processor 810 may generate wrinkles on the surface of the 3D padded garment by generating the auxiliary line and the inner line. The number of auxiliary lines is only an example, and the present disclosure is not limited thereto.

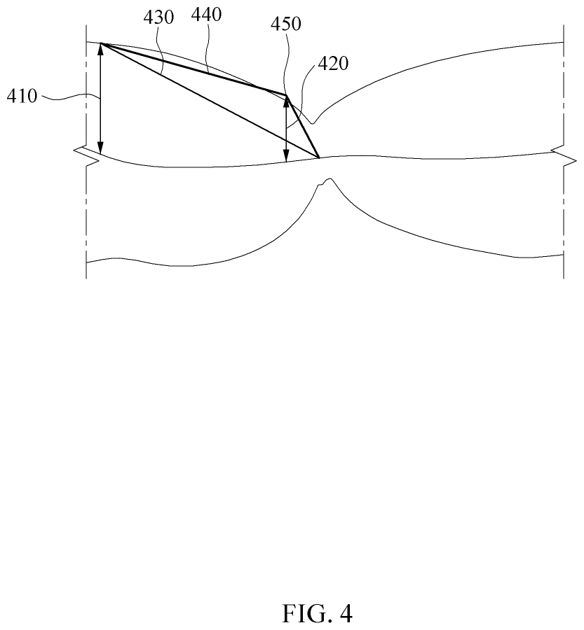

The processor 810 may determine the height of the padded section based on the pressure value. FIG. 4 is a diagram illustrating a collision value according to an embodiment. FIG. 4 shows the height 410 of the padded section, the collision value 420, the line 430, the line 440 and the curvature 450 of the padded surface.

The processor 810 may determine the height of the padded section based on the pressure value. Referring to FIG. 4, the height 410 of the padded section is shown. The height 410 of the padded section may be the maximum height of the padded section. For example, the height 410 of the padded section may be the maximum height from the intermediate surface of the 3D padded garment to the surface of the 3D padded garment. Alternatively, the height 410 of the padded section may be the height from the intermediate surface of the 3D padded garment to the first pattern (or the second pattern). As another example, the height 410 of the padded section may be a distance between the first pattern and the second pattern in the corresponding padded section. As the pressure value increases, the height 410 of the padded section may increase. Since the pressure value means a pressure applied outward from the surface of the 3D padded garment, the height 410 of the padded section may increase as the pressure increases.

The processor 810 may determine the curvature of the padded surface based on the collision value. Referring to FIG. 4, the collision value 420 is shown. When the collision value 420 is not set, the height of the padded section may increase proportionately as the distance from the inner line increases. For example, when the collision value 420 is not set, the surface of the 3D padded garment may be determined based on the line 430. Then, the surface of the 3D padded garment may have an unnatural appearance rather than a curved appearance. However, when the collision value 420 is set, the surface of the 3D padded garment may be determined based on the line 440. And based on the collision value 420, the curvature 450 of the padded surface may be determined. The curvature 450 of the padded surface may mean a curvature at a point of the padded surface. In this way, the processor 810 may allow the surface of the padded section to be curved as in an actual padded garment. Also, the processor 810 may determine the degree of swelling of the padded section based on the collision value.

The pressure value according to an embodiment may be determined based on at least one of an interval between inner lines and filling information. As shown in FIG. 2, the interval between inner lines according to an embodiment may be a distance between adjacent inner lines. The interval between inner lines according to an embodiment may be determined based on user input. For example, when the interval between inner lines input by a user is 7 mm, the processor 810 may determine the interval between inner lines to be 7 mm. According to another embodiment, the interval between the inner lines may be determined based on a predetermined reference. For example, the interval between the inner lines is discretely defined as 5, 6, 7, 9, 10, and 11 mm, and when a user input is 5.6 mm, the interval between the inner lines may be determined to be 6 mm.

The filling information according to an embodiment may include filling-related information. The filling according to an embodiment may refer to a material that fills inside the garment for warmth and cushioning effects. For example, the filling may include cotton, polyester, duck down, goose down, and wellon. The filling information according to an embodiment may include at least one of a filling material, a mass of a filling, and a weight of the filling.

As described above, patterns may be modeled by, for example, a mass-spring model. Since three vertices of the mesh have mass, vertices of the meshes included in the first pattern, the second pattern, and the intermediate pattern corresponding to the filling may also have mass.

The filling weight according to an embodiment may be set for each unit area of the pattern. The filling weight according to an embodiment may be set per unit area of the pattern (e.g., the intermediate pattern, the first pattern, and/or the second pattern). For example, unit areas of at least a portion of the first pattern or the second pattern may have the same or different weight per unit area (e.g., grams per square meter (g/m²)). For example, the unit area may be 1 square meter (m²). Users may set different weights per unit area in the intermediate pattern or set the same weights for all unit areas. Through this, users may simulate various types of 3D padded garments.

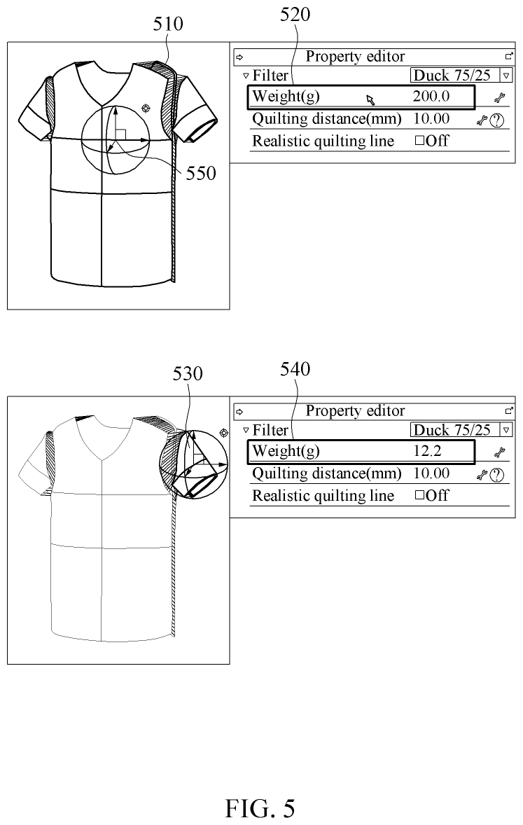

FIG. 5 is a diagram illustrating a method of determining filling information based on an area of pattern pieces, according to an embodiment. In FIG. 5, a 3D padded garment 510, a filling weight 520 of the 3D padded garment, an arm sleeve 530 of the 3D padded garment, a filling weight 540 corresponding to the arm sleeve of the 3D padded garment, and a pressure value 550 are illustrated.

When the 3D padded garment includes a plurality of pattern pieces, the processor 810 may determine filling information (e.g., a filling weight) assigned to each of the plurality of pattern pieces based on an area of each of the plurality of pattern pieces. The 3D padded garment 510 may be displayed on the display screen and the filling weight 520 of the 3D padded garment may be 200 g. In this case, when the processor 810 receives a selection input for a partial area of the 3D padded garment, the processor 810 may calculate the filling weight for the partial area. For example, the processor 810 may receive a selection input for the arm sleeve 530 of the 3D padded garment. In this case, the processor 810 may calculate the filling weight 540 based on an area of the arm sleeve 530 of the 3D padded garment. As shown in FIG. 5, the filling weight 540 of the arm sleeve portion may be 12.2 g. The filling weight 540 of the arm sleeve portion may be determined based on a ratio between the total 3D padded garment area and the arm sleeve portion area.

Referring to FIG. 5, users may input a filling weight 520 of the 3D padded garment. The processor 810 may receive an input of the filling weight (or the mass) from users. The processor 810 may determine an area in which the filling weight (or the mass) input based on user input is applied to the pattern (e.g., the first pattern and/or the second pattern). The processor 810 may determine an area in which the filling weight (or the mass) input based on user input is applied to a quilting section (e.g., an area existing in a predetermined distance from a quilting line). The processor 810 may calculate mass per unit area by determining the filling weight (or the mass) and an area to which the filling weight (or the mass) is applied. The processor 810 may output a realistic padded simulation result by differently setting the filling weight (or the mass) for each unit area of the pattern and/or quilting section.

The filling material information according to an embodiment may include filling material-related information. For example, the filling material may be cotton, polyester, duck down, goose down, wellon, or a combination thereof. When it is a combination, the filling material information may also include mixing ratio information. In addition, the filling material information may also include information related to the restoring force (e.g., fill power) of the filling. The filling weight according to an embodiment may mean the filling weight included in the 3D padded garment. The filling weight according to another embodiment may mean the filling weight included in at least a portion of the 3D padded garment.

The pressure value according to another embodiment may be determined based on at least one of a collision value, an interval between inner lines, and filling information.

The collision value according to an embodiment may be determined based on at least one of the intervals between the inner lines and the filling information.

The processor 810 according to an embodiment may adjust a size of a mesh included in the first pattern and the second pattern. The processor 810 according to an embodiment may adjust the size of a mesh included in the intermediate pattern. Depending on the size of the mesh, the simulating time may vary, and furthermore, the surface of the 3D padded garment may vary. For example, when the size of the mesh decreases, the operation amount increases, and thus the simulating time may increase. As another example, when the size of the mesh decreases, the surface of the 3D padded garment may be expressed smoothly.

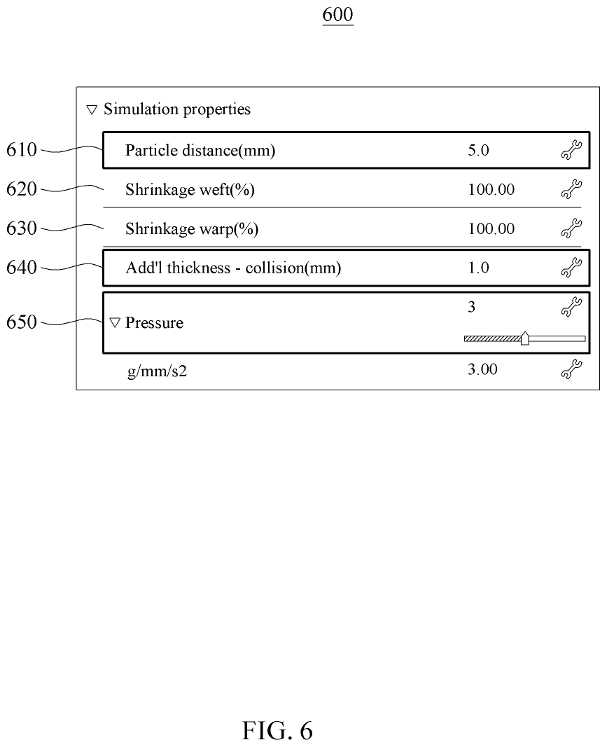

The processor 810 according to an embodiment may determine the size of the mesh of the first pattern and the second pattern and the size of the mesh of the intermediate pattern differently or the same. As shown in FIG. 6, users may set the size of the mesh by changing a particle distance 610. The particle distance 610 may mean a distance between points constructing a garment pattern and may be a factor determining a size of a mesh.

The processor 810 according to an embodiment may receive a selection input for a certain point in the 3D padded garment 510. In this case, the processor 810 may display the pressure value 550 of the point on the screen as shown in FIG. 5.

In FIG. 6, simulation properties of the 3D padded garment are displayed, and the particle distance 610, the shrinkage weft 620, the shrinkage warp 630, the collision value 640, and the pressure value 650 may be displayed.

The particle distance 610 according to an embodiment may mean a distance between points constructing a garment pattern and may be a factor determining a size of a mesh. The shrinkage weft 620 according to an embodiment may mean a shrinkage rate in a weft direction, and the shrinkage warp 630 may mean a shrinkage rate in a warp direction.

The collision value 640 according to an embodiment may mean a value for adjusting a curvature of the padded surface. The pressure value 650 according to an embodiment may mean a pressure applied outward from the surface of the 3D padded garment.

As the processor 810 displays simulation properties of the 3D padded garment on the screen, users may identify what property values the 3D padded garment has.

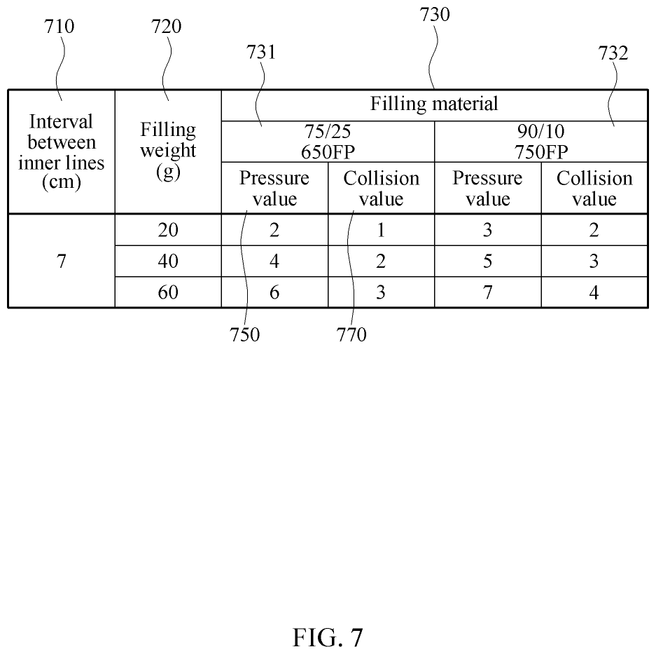

FIG. 7 is a diagram illustrating information for determining a pressure value and a collision value according to an embodiment. In FIG. 7, an interval 710 between inner lines, a filling weight 720, a filling material 730, a first filling material 731, a second filling material 732, a pressure value 750, and a collision value 770 are shown.

The pressure value 750 according to an embodiment may be determined based on the interval 710 between the inner lines, the filling weight 720, and/or the filling material 730. The collision value 770 according to an embodiment may be determined based on the interval 710 between the inner lines, the filling weight 720, and/or the filling material 730.

The filling material 730 may include a material with several materials mixed. For example, the first filling material 731 may be 75/25 650FP. 75/25 may mean that a ratio of cotton and down is mixed at a ratio of 75% to 25%. 650FP may mean 650 fill power. The fill power may mean the resilience of down products. As another example, the second filling material 732 may be 90/10 750FP. Accordingly, the second filling material 732 is a mixture of cotton and down at a ratio of 90% to 10% and may have 750 fill power.

The table shown in FIG. 7 shows the pressure value 750 and the collision value 770 corresponding to the interval 710 between the inner lines, the filling weight 720, and the filling material 730. For example, when the interval 710 between the inner lines is 7 cm, the filling weight is 20 g, and the filling material is 75/25 650FP, the pressure value 750 will be 2 and the collision value 770 will be 1. The above description is merely an example, and the present disclosure is not limited thereto.

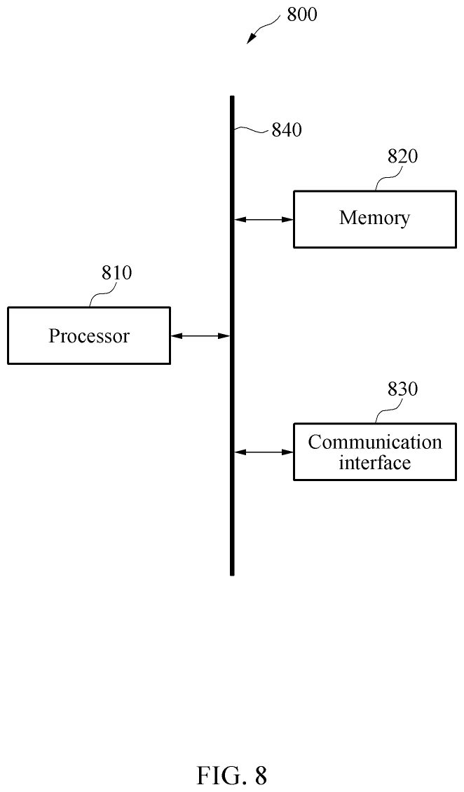

FIG. 8 is a block diagram illustrating an electronic device according to various embodiments. FIG. 8 is a block diagram illustrating an electronic device according to an embodiment. The electronic device according to an embodiment may be a server. The electronic device according to another embodiment may be a terminal (e.g., a mobile terminal, a laptop, a desktop, etc.). Referring to FIG. 8, an electronic device 800 may include a memory 820, a processor 810, and a communication interface 830. The memory 820, the processor 810, and the communication interface 830 may be connected to each other via a communication bus 840.

The memory 820 may store a variety of information generated in the processing process of the processor 810 described above. In addition, the memory 820 may store a variety of data and programs. The memory 820 may include a volatile memory or a non-volatile memory. The memory 820 may include a high-capacity storage medium such as a hard disk and store a variety of data.

The processor 810 may be a hardware-implemented apparatus having a circuit that is physically structured to execute desired operations. The desired operations may include, for example, code or instructions included in a program. The hardware-implemented apparatus may include, but is not limited to, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

The processor 810 may execute a program and control the electronic device. Code of the program executed by the processor 810 may be stored in the memory 820.

The examples described herein may be implemented using hardware components, software components and/or combinations thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded in the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

What is claimed is:

1. A method of simulating a three-dimensional (3D) padded garment, the method comprising:
receiving a two-dimensional shape of a first pattern of the 3D padded garment;
generating a two-dimensional shape of a second pattern of the 3D padded garment, the second pattern to be combined with the first pattern with an intermediate pattern sandwiched between the first pattern and the second pattern to form at least a portion of the 3D padded garment;
simulating an appearance of the 3D padded garment by:
simulating applying of internal pressure by the intermediate pattern as defined by a pressure value to an internal surface of the first pattern facing the second pattern and an internal surface of the second pattern facing the first pattern, and
performing collision processing of the intermediate pattern, the first pattern and the second pattern by applying a collision value of the intermediate pattern representing a collision processing range of the intermediate pattern; and
displaying a result of the simulating of the appearance of the 3D padded garment.

2. The method of claim 1, further comprising automatically generating the intermediate pattern.

3. The method of claim 1, wherein the intermediate pattern is not displayed.

4. The method of claim 1, wherein simulating the appearance of the 3D padded garment comprises transforming the first pattern and the second pattern in 3D space based on at least one of physical property of the first pattern, physical property of the second pattern, the pressure value or the collision value.

5. The method of claim 1, further comprising generating a configuration of the 3D padded garment by generating at least one sewing line that combines the first pattern, the second pattern, and the intermediate pattern based on an interval of the sewing line, the simulating of the appearance of the 3D padded garment performed based on the configuration of the 3D padded garment.

6. The method of claim 5, wherein the sewing line defines a plurality of padded sections in the 3D padded garment.

7. The method of claim 5, further comprising:
generating another sewing line parallel to the sewing line and spaced apart by a predetermined distance from the sewing line, the simulating of the appearance of the 3D padded garment performed based on the sewing line and the other sewing line.

8. The method of claim 7, further comprising:
generating a wrinkle on a padded surface based on the sewing line and the other sewing line.

9. The method of claim 7, wherein simulating the appearance of the 3D padded garment is performed by applying an elastic value to at least one of the sewing line or the other sewing line.

10. The method of claim 3, further comprising determining a height of a padded section including the intermediate pattern based on the pressure value.

11. The method of claim 1, wherein the pressure value comprises at least one of:
a first pressure value applied to the internal surface of the first pattern in a direction opposite to the second pattern; or
a second pressure value applied to the internal surface of the second pattern in a direction opposite to the first pattern.

12. The method of claim 5, further comprising determining a curvature of a padded surface by adjusting, based on the collision value, a gap between the first pattern and the second pattern with an increase in distance from the sewing line.

13. The method of claim 1, further comprising determining the pressure value based on at least one of an interval between sewing lines and filling information indicating materials that fill the 3D padded garment, and
wherein the collision value is determined based on at least one of the intervals between sewing lines connecting the first pattern and the second pattern, and the filling information.

14. The method of claim 1, further comprising determining filling information of each of a plurality of patterns of the 3D padded garment based on an area of each of the plurality of patterns, the filling information indicating materials that fill the 3D padded garment.

15. The method of claim 1, further comprising:
adjusting a size of a mesh in the first pattern and the second pattern; or
adjusting a size of a mesh in the intermediate pattern.

16. The method of claim 13, wherein the filling information indicates at least one of a filling material, a mass of a filling that fills the 3D padded garment, or a weight of the filling.

17. The method of claim 16, wherein the weight of the filling is set for each unit area of the intermediate pattern.

18. A non-transitory computer readable storage medium storing instruction thereon, the instructions when executed by a processor cause the processor to:
receive a two-dimensional shape of a first pattern of a three-dimensional (3D) padded garment;
generate a two-dimensional shape of a second pattern of the 3D padded garment, the second pattern to be combined with the first pattern with an intermediate pattern sandwiched between the first pattern and the second pattern to form at least a portion of the 3D padded garment;
simulate an appearance of the 3D padded garment by:
simulating applying of internal pressure by the intermediate pattern as defined by a pressure value to an internal surface of the first pattern facing the second pattern and an internal surface of the second pattern facing the first pattern, and
performing collision processing of the intermediate pattern, the first pattern and the second pattern by applying a collision value of the intermediate pattern representing a collision processing range of the intermediate pattern; and
display a result of the simulating of the appearance of the 3D padded garment.

19. The non-transitory computer readable storage medium of claim 18, further storing instructions causing the processor to automatically generate the intermediate pattern.

20. An electronic device comprising:
a processor; and
a non-transitory computer readable storage medium storing instructions thereon, the instructions cause the processor to:
receive a two-dimensional shape of a first pattern of a three-dimensional (3D) padded garment;
generate a two-dimensional shape of a second pattern of the 3D padded garment, the second pattern to be combined with the first pattern with an intermediate pattern sandwiched between the first pattern and the second pattern to form at least a portion of the 3D padded garment;
simulate an appearance of the 3D padded garment by:
simulating applying of internal pressure by the intermediate pattern as defined by a pressure value to an internal surface of the first pattern facing the second pattern and an internal surface of the second pattern facing the first pattern, and
performing collision processing of the intermediate pattern, the first pattern and the second pattern by applying a collision value of the intermediate pattern representing a collision processing range of the intermediate pattern; and
display a result of the simulating of the appearance of the 3D padded garment.
